(19) United States
(12) Patent Application Publication
(10) Pub. No.: US 2018/0097265 A1
(43) Pub. Date: Apr. 5, 2018

(54) SEALED BATTERY COMPARTMENT IN ELECTRIC VEHICLE

(71) Applicant: Faraday&Future Inc., Gardena, CA (US)

(72) Inventors: David Tarlau, Torrance, CA (US); Victor Bustoba Tabelin, JR., Temple City, CA (US)

(21) Appl. No.: 15/283,136

(22) Filed: Sep. 30, 2016

(51) Int. Cl. H01M 10/625; H01M 10/6568; H01M 10/613; H01M 2/10; B60L 11/18

(52) U.S. Cl. CPC H01M 10/625; H01M 10/6568; H01M 10/613; H01M 2220/20; B60L 11/1877; B60L 11/1874; H01M 2/1077

(57) ABSTRACT

Systems and methods for improving an electric vehicle are disclosed. Systems and methods may include an housing enclosure for an electric vehicle battery module that is configured to include a coolant inlet and a coolant outlet. The housing enclosure may include an upper portion and a lower portion that are coupled together at a mating surface via a gasket. The gasket may provide a long lasting seal that prevents coolant from leaking into or out of the mating surface of the housing enclosure. The systems and methods may include a plurality of electrochemical cells disposed within the housing enclosure.

### FIELD

The present disclosure relates generally to electric vehicles. More specifically, the present disclosure relates to a sealed battery compartment for electric vehicles.

### BACKGROUND

Electric-drive vehicles may promote the use of sustainable energy and reduce the environmental impact of vehicles powered by engines that burn fossil fuels. Electric-drive vehicles utilize energy-storage systems, such as batteries, to power an electric motor. Drawbacks to electric-drive vehicle energy-storage systems include difficulty regulating the temperature of battery cells and difficulty regulating the energy balance between battery cells. The current disclosure may be directed to addressing one or more of the possible drawbacks discussed above and/or other problems of the prior art.

### SUMMARY

The systems and methods of this disclosure each have several innovative aspects, no single one of which is solely responsible for its desirable attributes. Without limiting the scope as expressed by the claims that follow, some prominent features of this disclosure will now be discussed briefly.

Some embodiments disclosed herein relate to an electric vehicle that may include a housing enclosure having an upper portion and a lower portion. The upper portion may include a mating surface and the lower portion may include a mating surface. The mating surface of the upper portion may be configured to mate with the mating surface of the lower portion. The electric vehicle may include a plurality of battery modules disposed within the housing enclosure, and each battery module may include a plurality of rechargeable electrochemical cells. The electric vehicle may include a cooling system configured to supply coolant to the battery modules that may be disposed within the housing enclosure. The cooling system may include one or more coolant inlets capable of providing one or more coolant flow paths into the housing enclosure, and the cooling system may include one or more coolant outlets capable of providing one or more coolant flow paths out of the housing enclosure. In some embodiments, the coolant may be poly-alpha-olefin oil. In some embodiments, the poly-alpha-olefin oil may be a polymer oil having 1-decene or 1-dodecene monomer units. The electric vehicle may include a gasket positioned between the mating surfaces of the upper and lower portions of the housing enclosure, and four or more bolts or screws may provide a clamping force that compresses the gasket between the mating surfaces of the upper and lower portions of the housing enclosure, which may form a seal between the mating surfaces of the upper and lower portions of the housing enclosure. The seal may prevent ingress and egress of the coolant through the mating surfaces of the upper and lower portions of the housing enclosure. In some embodiments, a torque of at least 25 foot-pounds may be applied to each of the four or more bolts or screws. In some embodiments, the gasket may be compressed by a clamping force of at least 25 pounds per square inch. In some embodiments, the gasket may be made from a nitrile rubber material. In some embodiments, the nitrile rubber may be a copolymer of 2-propenenitrile and butadiene monomer units having a range of 30%-45% 2-propenitrile monomer units. In some embodiments, the nitrile rubber may be a copolymer having a range of 30%-35% 2-propenitrile monomer units. In some embodiments, the gasket positioned between the mating surfaces of the upper and lower portions of the housing enclosure may have a thickness of 0.010-0.200 inches in its non-compressed state.

Some embodiments disclosed herein relate to an electric vehicle that may include a housing enclosure having an upper portion and a lower portion. The upper portion may include a mating surface and the lower portion may include a mating surface. The mating surface of the upper portion may be configured to mate with the mating surface of the lower portion. The electric vehicle may include a plurality of battery modules disposed within the housing enclosure, and each battery module may include a plurality of rechargeable electrochemical cells. The electric vehicle may include a cooling system configured to supply coolant to the battery modules that may be disposed within the housing enclosure. The cooling system may include one or more coolant inlets capable of providing one or more coolant flow paths into the housing enclosure, and the cooling system may include one or more coolant outlets capable of providing one or more coolant flow paths out of the housing enclosure. In some embodiments, the coolant may be poly-alpha-olefin oil. In some embodiments, the poly-alpha-olefin oil may be a polymer oil having 1-decene or 1-dodecene monomer units. The electric vehicle may include a gasket positioned between the mating surfaces of the upper and lower portions of the housing enclosure, and a means for compressing the gasket between the mating surfaces of the upper and lower portions of the housing enclosure, which may form a seal between the mating surfaces of the upper and lower portions of the housing enclosure. The seal may prevent ingress and egress of the coolant through the mating surfaces of the upper and lower portions of the housing enclosure. In some embodiments, the means for compressing the gasket includes four or more bolts or screws, wherein each of the bolts or screws may be tightened with a torque of at least 25 foot-pounds. In some embodiments, the means for compressing the gasket may produce a clamping force of at least 25 pounds per square inch. In some embodiments, the gasket may be made from a nitrile rubber material. In some embodiments, the nitrile rubber may be a copolymer of 2-propenenitrile and butadiene monomer units having a range of 30%-45% 2-propenitrile monomer units. In some embodiments, the nitrile rubber may be a copolymer having a range of 30%-35% 2-propenitrile monomer units. In some embodiments, the gasket positioned between the mating surfaces of the upper and lower portions of the housing enclosure may have a thickness of 0.010-0.200 inches in its non-compressed state.

Some embodiments disclosed herein relate to a method of preventing leakage of coolant within an electric vehicle that may include placing a gasket between mating surfaces of a battery module housing enclosure. The battery module housing enclosure may include an upper portion and a lower portion, and the upper portion may include a mating surface and the lower portion may include a mating surface. The mating surface of the upper portion may be configured to mate with the mating surface of the lower portion. The battery module housing enclosure may include a plurality of battery modules that may be disposed within the housing enclosure, and each battery module may include a plurality of rechargeable electrochemical cells. In some embodiments, the method may include compressing the gasket between the mating surfaces of the upper and lower portions of the housing enclosure, which may form a seal between the mating surfaces of the upper and lower portions of the housing enclosure. In some embodiments, the method may include flowing a coolant into the battery module housing enclosure through one or more coolant inlets. The coolant may flow into each of the battery modules disposed within the battery module housing enclosure, and the coolant may flow out of each of the battery modules, and the coolant may further flow out of the battery module housing enclosure through one or more coolant outlets. In some embodiments, the coolant may be poly-alpha-olefin oil. In some embodiments, the poly-alpha-olefin oil may be a polymer oil having 1-decene or 1-dodecene monomer units. In some embodiments, the gasket may be made from a nitrile rubber material. In some embodiments, the nitrile rubber may be a copolymer of 2-propenenitrile and butadiene monomer units having a range of 30%-45% 2-propenitrile monomer units. In some embodiments, the nitrile rubber may be a copolymer having a range of 30%-35% 2-propenitrile monomer units. In some embodiments, the gasket may be compressed by a force of at least 25 pounds per square inch. In some embodiments, the gasket may be compressed by four or more bolts or screws. In some embodiments, the each of the bolts or screws may be tightened with a torque of at least 25 foot-pounds. In some embodiments, the gasket that is placed between the mating surfaces of the upper and lower portions of the housing enclosure may have a thickness of 0.010-0.200 inches before it is compressed.

### BRIEF DESCRIPTION OF THE DRAWINGS

The following is a brief description of each of the drawings. The drawings are merely examples and are not intended to be limiting. The drawings do not set forth all embodiments of this disclosure. Other embodiments may be used in addition to or instead. Conversely, some embodiments may be practiced without all of the details that are disclosed in the drawings. Throughout the drawings, similar symbols typically identify similar components, unless context dictates otherwise. The drawings may not be drawn to any particular proportion or scale.

FIG. 1 is a diagrammatic illustration of an exemplary electric vehicle having an exemplary battery pack.

FIG. 2 is a diagrammatic illustration of the exemplary battery pack of FIG. 1 when removed from the electric vehicle.

FIG. 3A is a diagrammatic illustration of the exemplary battery pack of FIG. 2 disposed in an exemplary housing enclosure. FIG. 3B is a diagrammatic illustration of an exemplary lower portion of an exemplary housing enclosure.

FIGS. 4A and 4B are diagrammatic illustrations of exemplary coolant flow paths in the exemplary battery pack of FIG. 2. FIG. 4B is an enlarged module of the battery pack depicted in FIG. 4A.

FIG. 5A and 5B are diagrammatic illustrations of an exemplary coupling arrangement between two exemplary battery modules shown apart in FIG. 5A and coupled together in FIG. 5B. A plurality of modules may be joined together as shown, for example, in FIG. 2.

FIG. 6 is a diagrammatic illustration of the internal components of the module of FIG. 5A.

FIG. 7 is a diagrammatic illustration of an exemplary battery module of FIG. 6 with the current carrier and battery cells removed from one of the half modules of the battery module.

FIG. 8 is a diagrammatic illustration of an exemplary battery module of FIG. 6 with the current carrier removed from one of the half modules of the battery module.

FIG. 9 is a diagrammatic illustration of an exemplary half module.

FIG. 10 is a diagrammatic illustration of an exemplary battery cell.

FIG. 11 is a diagrammatic illustration of an exemplary current carrier.

FIG. 12 schematically illustrates various components of a modular battery string in accordance with an exemplary embodiment.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways.

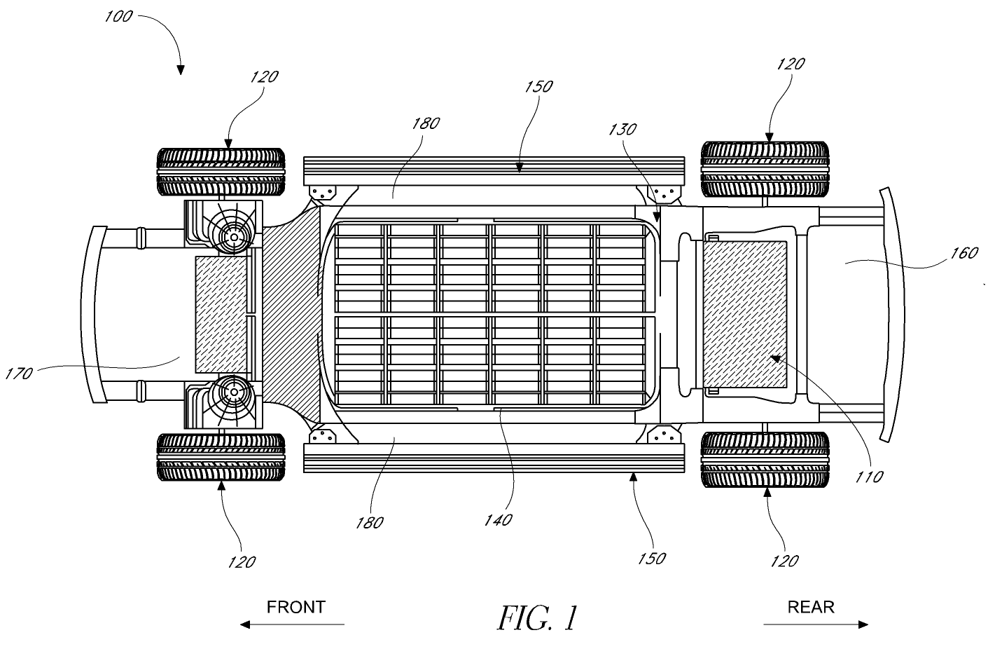

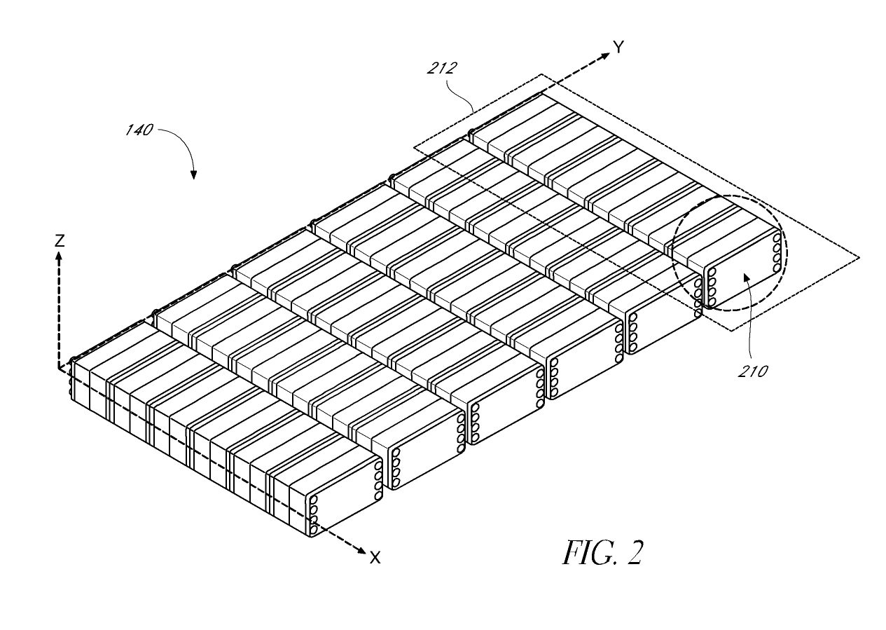

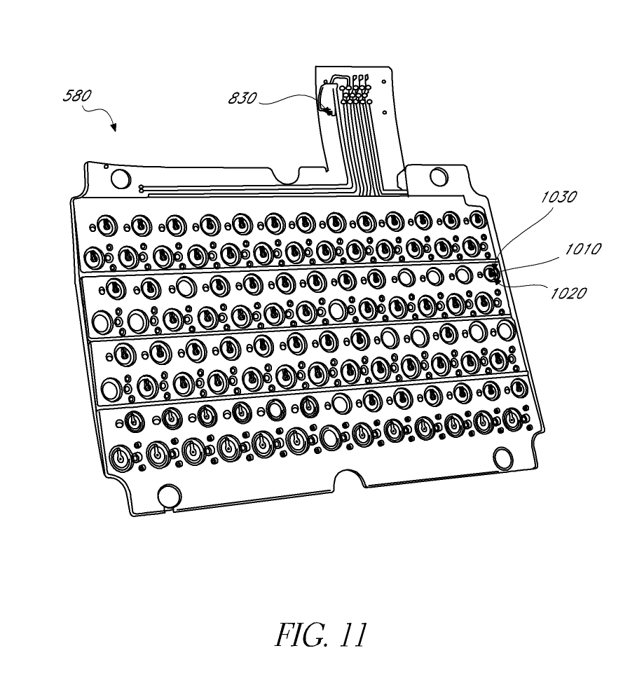

FIGS. 1-12 illustrate exemplary components and systems for an electric vehicle. The electric vehicle may be implemented as a vehicle of any type. For example, the electric vehicle may be a car, truck, semi-truck, motorcycle, plane, train, moped, scooter, or other type of transportation. Furthermore, the electric vehicle may use many types of powertrain. For example, the electric vehicle may be a plug-in electric vehicle, a plug-in hybrid electric vehicle, a hybrid electric vehicle, or a fuel cell vehicle.

FIG. 1 is a diagrammatic illustration of an exemplary electric vehicle 100. Electric vehicle 100 may propelled by one or more electric motors 110. Electric motor 110 may be coupled to one or more wheels 120 through a drivetrain (not shown in FIG. 1). Electric vehicle 100 may include a frame 130 (alternatively known as an underbody or chassis). Frame 130 may be a supporting structure of electric vehicle 100 to which other components may be attached or mounted, such as, for example, a battery pack 140.

Electric vehicle 100 may further include structural rails 150, rear crumple zone 160, front crumple zone 170, and lateral crumple zone 180. Battery pack 140 may have a compact “footprint” and be disposed such that it may be at least partially enclosed by frame 130. Battery pack 140 may be positioned at a predefined distance from structural rails 150. In some embodiments, battery pack 140 may be positioned such that frame 130, structural rails 150, rear crumple zone 160, front crumple zone 170, and lateral crumple zone 180 protect battery pack 140 from forces or impacts exerted from outside of electric vehicle 100, for example, in a collision. In some embodiments, battery pack 140 may be disposed in frame 130 to help improve directional stability (e.g., yaw acceleration). For example, battery pack 140 may be disposed in frame 130 such that a center of gravity of electric vehicle 100 may be in front of the center of the wheelbase (e.g., it may be bounded by a plurality of wheels 120).

FIG. 2 is a diagrammatic illustration of exemplary battery pack 140. Imaginary x-, y-, and z-axes are depicted on battery pack 140. Battery pack 140 may be of any size and dimensions. For example, battery pack 140 may be approximately 1000 mm wide (along x-axis), 1798 mm long (along y-axis), and 152 mm high (along z-axis).

In some embodiments, battery pack 140 may be modular and/or subdivided into smaller functional units. For example, battery pack 140 may include a plurality of battery modules 210. In some embodiments, each battery module comprises a plurality of rechargeable electrochemical cells, such as, for example, lithium ion battery cells. In one example, battery pack 140 may include thirty-six battery modules 210. At least some of battery modules 210 may be electrically connected in a series forming a string 212, and two or more strings 212 may be electrically connected in parallel. In various embodiments, modular battery configurations may be advantageous, for example, by allowing the battery pack 140 to continue operating despite the failure or malfunction of one or more strings 212, such as by disconnecting the malfunctioning strings 212. In this exemplary configuration, if one of strings 212 fails, others of strings 212 may not be affected.

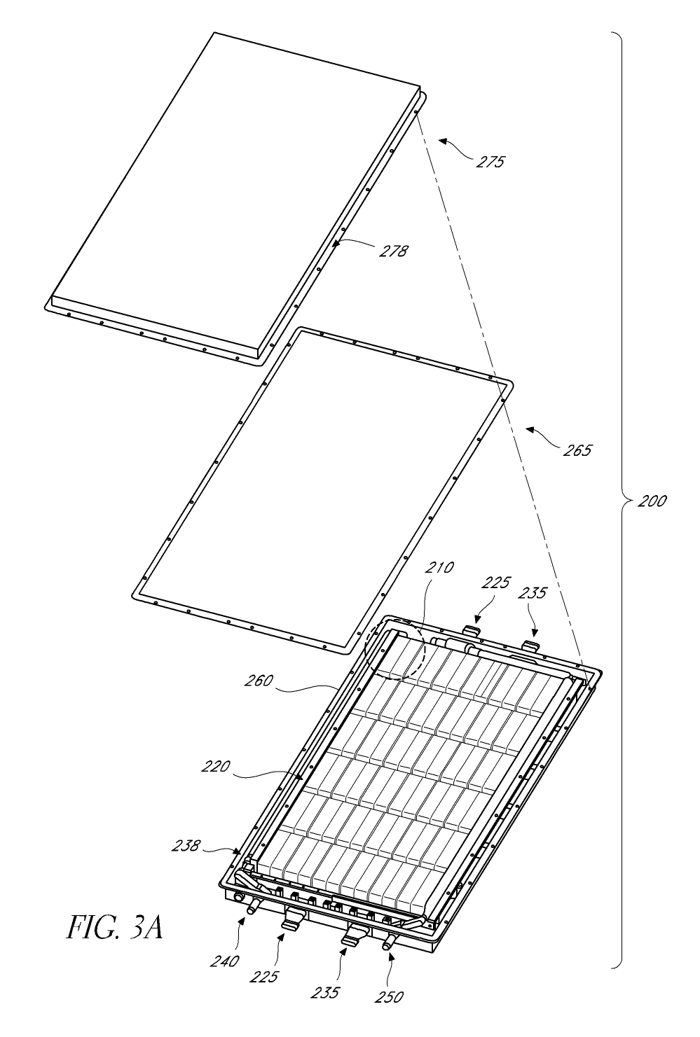

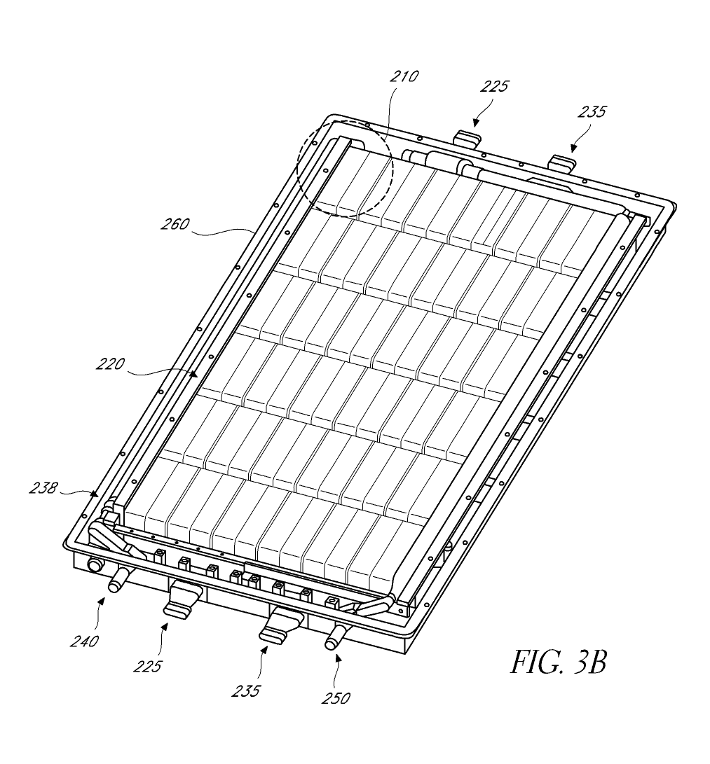

FIG. 3A depicts exemplary battery pack 140 in an exemplary housing enclosure 200. Housing enclosure 200 includes a lower portion, such as lower portion 260. Housing enclosure 200 further includes an upper portion, such as upper portion 275, that covers or encloses the lower portion. The upper portion and the lower portion may be coupled with a gasket, such as gasket 265. The gasket may fill the space between the mating surfaces of the upper and lower portions, such as mating surface 278 of the upper portion 275 and the mating surface 238 of the lower portion 260. The gasket may serve to create a fluid impermeable seal that prevents fluid from leaking into or out of the housing enclosure. In some embodiments, the gasket may be a single piece. In some embodiments, the gasket may comprise two or more pieces. In some embodiments, the fluid that is prevented from leaking into our out of the housing enclosure is a coolant liquid. FIG. 3B depicts an enlarged exemplary lower portion 260 of an exemplary housing enclosure 200.

The gasket may comprise a material selected from one or more of the following: rubber, silicone, metal, fiberglass, graphite, cork, polytetrafluoroethylene, polychlorotrifluoroethylene, neoprene, and nitrile rubber. The gasket material may be deformable such that the gasket tightly fills the space between the mating surfaces of the upper and lower portions while under compression.

The gasket may be compressed by means for generating a clamping force that secures the gasket between the mating surfaces of the upper and lower portions of the housing enclosure by about or any number in between the range of about 1-5, 3-8, 5-10, 8-12, 10-15, 12-20, 15-25, 10-30, 20-40, 30-50, 40-60, 50-70, 60-80, 70-90, 80-100, or more than 100 pounds per square inch. The gasket may be compressed by means for generating a clamping force that secures the gasket between the mating surfaces of the upper and lower portions of the housing enclosure by a clamping force of at least 5, at least 10, at least 15, at least 20, at least 25, at least 30, at least 40, at least 50, at least 60, at least 70, at least 80, at least 90, or at least 100 pounds per square inch. The clamping force securing the gasket between the mating surfaces is sufficient to prevent fluid from leaking into and out of the housing enclosure. The means for generating a clamping force can include four or more bolts or screws, or two or more fasteners or clamps, which secure the mating surfaces of the upper and lower portions of the housing enclosure to each other. In some embodiments, the number of bolts or screws securing the mating surfaces of the upper and lower portions may be 4, 5, 6, 7, 8, 9, 10, 11, 12, 13, 14, 15, 16, 17, 18, 19, 20, or more than 20. In some embodiments, the torque applied to tighten each of the bolts or screws may be at least about or any number in between the range of about 5-20, 10-30, 20-40, 30-50, 40-60, 50-70, 60-80, 70-90, 80-100, 90-110, 100-120, 110-130, 120-140, 130-150, or more than 150 foot-pounds. In some embodiments, the torque applied to tighten each of the bolts or screws may be at least 5, at least 10, at least 20, at least 25, at least 30, at least 40, at least 50, at least 60, at least 70, at least 80, at least 90, at least 100, at least 110, at least 120, at least 130, or at least 150 foot-pounds. In some embodiments, the number of fasteners or clamps securing the mating surfaces of the upper and lower portions may be 2, 3, 4, 5, 6, 7, 8, 9, 10, 11, 12, or more than 12.

In some embodiments, the thickness of the gasket in its uncompressed state may range from about or any number in between 0.010-0.030, 0.020-0.040, 0.030-0.050, 0.040-0.060, 0.050-0.070, 0.060-0.080, 0.070-0.090, 0.080-0.100, 0.090-0.110, 0.110-0.130, 0.120-0.140, 0.130-0.150, 0.140-0.160, 0.150-0.170, 0.160-0.180, 0.170-0.190, 0.180-0.200, 0.190-0.210, 0.200-0.220, or 0.210-0.230 inch.

In some embodiments, the gasket comprises nitrile rubber. Nitrile rubber is a copolymer of 2-propenenitrile and butadiene monomers. The butadiene monomers are either 1,2-butadiene or 1,3-butadiene, or mixtures of both 1,2-butadiene and 1,3-butadiene. The 2-propenenitrile monomer unit content in the nitrile rubber ranges from about 15% to 45%. The amount of 2-propenenitrile monomer unit in the nitrile rubber may be in the range of about 30%-45% to improve the resistance of the nitrile rubber gasket to degradation by oils relative to a 2-propenenitrile monomer unit content of about 15%-25%. The amount of 2-propenenitrile monomer unit content in the nitrile rubber may be in the range of about 15%-25% to increase the flexibility of the nitrile rubber gasket relative to a 2-propenenitrile monomer unit content of about 30%-45%. In some embodiments, the amount of 2-propenenitrile monomer unit in the nitrile rubber gasket may be in the range of about 30%-35% to provide resistance to oil and to provide flexibility to create a fluid impermeable seal between the upper and lower portions of the housing enclosure. In some embodiments, the amount of 2-propenenitrile monomer unit in the nitrile rubber gasket ranges from about or any number in between 15%-20%, 17%-22%, 20%-25%, 22%-27%, 25%-30%, 27%-32%, 30%-35%, 32%-37%, 35%-40%, 37%-42%, or 40%-45%. In some embodiments, the amount of butadiene monomer unit in the nitrile rubber gasket ranges from about or any number in between 85%-80%, 83%-88%, 80%-75%, 78%-73%, 75%-70%, 73%-68%, 70%-65%, 68%-63%, 65%-60%, 63%-58%, or 60%-55%. In some embodiments, the nitrile rubber may be sulfur-cured or peroxide-cured. In some embodiments, the nitrile rubber may contain ester plasticizers or non-ester plasticizers. In some embodiments, the nitrile rubber may contain mineral fillers. In some embodiments, the nitrile rubber may contain carbon black as a filler to increase the tensile strength and abrasion resistance of the rubber.

Applicants have surprisingly found that the use of nitrile rubber as a gasket in an electric vehicle provides a longer lasting seal for the prevention of coolant leakage from a battery pack housing enclosure as compared with the use of other gasket materials in electric vehicles. In particular, applicants have surprisingly found that the use of nitrile rubber as a gasket in an electric vehicle provides a synergistic combination with the use of poly-alpha-olefin oil as a coolant, which unexpectedly provides a long lasting seal for the prevention of coolant leakage from a battery pack housing enclosure in an electric vehicle as compared with the use of other gasket materials and coolants in electric vehicles. The combination of other gasket materials and coolants do not provide seals that last as long for preventing coolant leakage from a battery pack housing enclosure in an electric vehicle.

Tray 260 may include a positive bus bar 220 and a negative bus bar 230. Negative bus bar 230 and positive bus bar 220 may be disposed along opposite edges of tray 260, or may be disposed to have a predefined separation between negative bus bar 230 and positive bus bar 220.

Positive bus bar 220 may be electrically coupled to a positive portion of a power connector of battery modules 210 within the battery pack 140. Negative bus bar 230 may be electrically coupled to a negative portion of a power connector of battery modules 210 within the battery pack 140. Positive bus bar 220 may be electrically coupled to positive terminals 225 of enclosure 200. Negative bus bar 230 may be electrically coupled to negative terminals 235 of enclosure 200. When used in electric vehicle 100, bus bars 220 and 230 may be disposed within structural rails 150.

In electric vehicle 100, battery pack 140 may supply electricity to power one or more electric motors 110, for example, through an inverter. The inverter may change direct current (DC) from battery pack 140 to alternating current (AC), as may be required for electric motors 110, according to some embodiments.

Liquid cooling may be desirable for various battery pack configurations by providing efficient heat transfer in relatively compact battery configurations, so as to provide reliable temperature regulation and maintain battery cells within a desired range of operating temperatures. In liquid cooled embodiments, coolant may enter the battery pack 140 at a coolant inlet 240 and may leave at a coolant outlet 250.

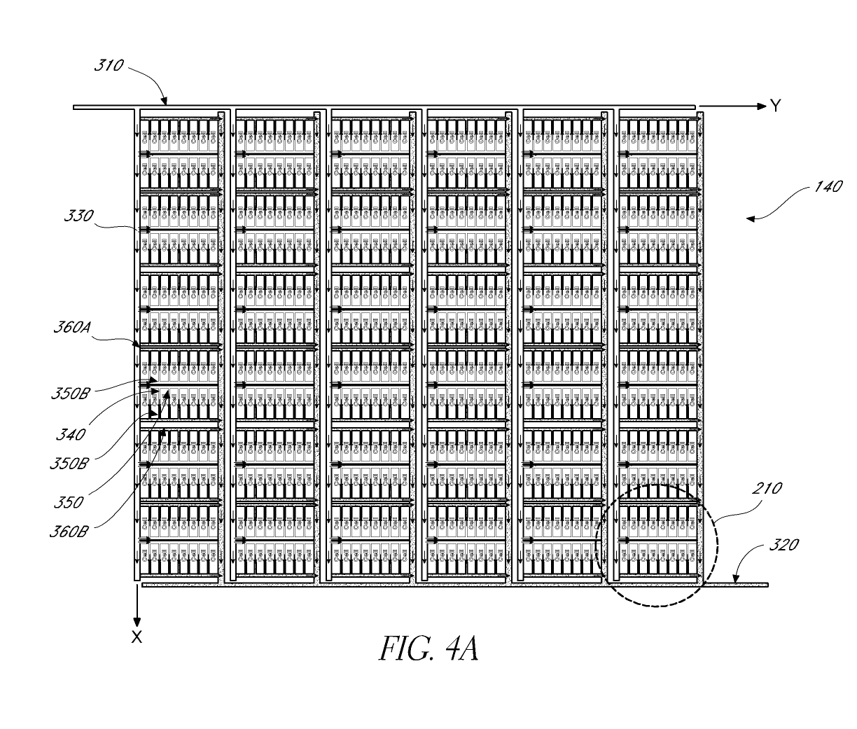

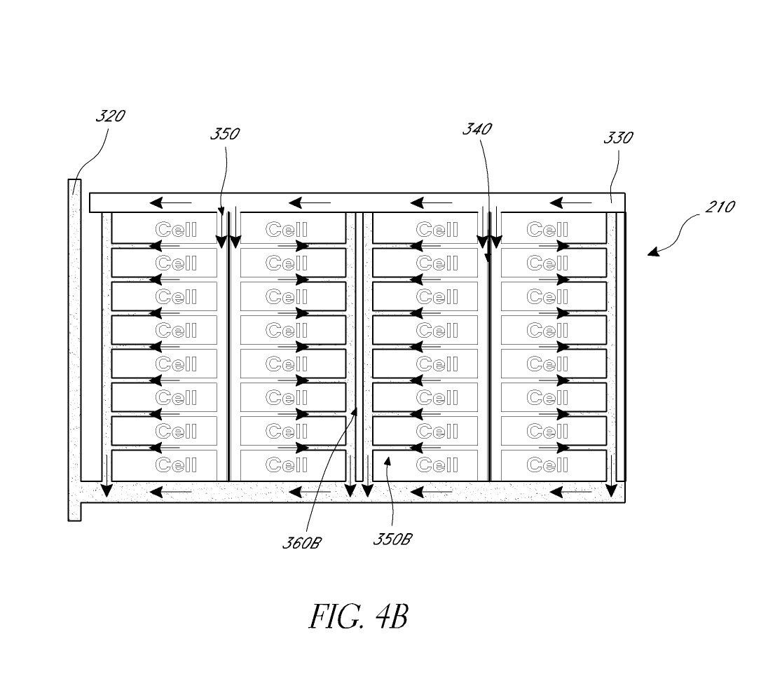

FIGS. 4A and 4B illustrate exemplary coolant flows and the exemplary operation of an exemplary coolant system and an exemplary coolant sub-system that may be used in conjunction with battery pack 140. FIG. 4B is an enlarged module 210 of the pack 140 depicted in FIG. 4A. As depicted in FIGS. 4A and 4B, an exemplary coolant system may include an ingress 310 and an egress 320. For example, coolant may be pumped into battery pack 140 at ingress 310 and pumped out of battery pack 140 at egress 320. For example, coolant may be routed in parallel to each of battery modules 210 in battery pack 140. The resulting pressure gradient within battery pack 140 may provide sufficient circulation of coolant to minimize a temperature gradient within battery pack 140 (e.g., a temperature gradient within one of battery modules 210, a temperature gradient between battery modules 210, and/or a temperature gradient between two or more of strings 212 shown in FIG. 2).

Within battery pack 140, the coolant system may circulate the coolant, for example, to battery modules 210 (e.g., reference numeral 330 indicates the circulation). Coolant may include at least one of the following: synthetic oil, for example, poly-alpha-olefin (or poly-α-olefin, also abbreviated as PAO) oil, ethylene glycol and water, liquid dielectric cooling based on phase change, perfluorohexane (Flutec PP1), perfluoromethylcyclohexane (Flutex PP2), perfluoro-1,3-dimethylcyclohexane (Flutec PP3), perfluorodecalin (Flutec PP6), perfluoromethyldecalin (Flutec PP9), trichlorofluoromethane (Freon 11), trichlorotrifluoroethane (Freon 113), methanol, ethanol, and the like.

In some embodiments, the coolant comprises poly-alpha-olefin oil. Poly-alpha-olefin oil is a polymer comprising 1-alkene monomers (also known as α-alkene monomers). In some embodiments, the 1-alkene monomers may be selected from one or more of the following monomers: ethylene (C2), 1-butene (C4), 1-hexene (C6), 1-octene (C8), 1-decene (C10), 1-dodecene (C12), 1-tetradecene (C14), 1-hexadecene (C16), 1-octadecene (C18), and 1-icosene (C20). In some embodiments, odd-numbered 1-alkenes may be monomers, such as one or more of 1-propene (C3), 1-pentene (C5), 1-heptene (C7), 1-nonene (C9), and the like. In some embodiments, branched 1-alkenes may be monomers, such as isopropene, isobutene, 2-ethyl-1-hexene, 2-ethyl-1-octene, and the like. In some embodiments, the poly-alpha-olefin oil comprises a mixture of polymers comprising one or more 1-alkene monomers. Applicants have surprisingly found that the use of poly-alpha-olefin oil as a coolant in an electric vehicle provides greater thermal stability, greater oxidative stability, and improved low temperature fluidity as compared with the use of other coolants in electric vehicles.

In some embodiments, when coolant is poly-alpha-olefin oil, the gasket does not comprise a significant amount of material selected from one or more of the following: silicone, metal, fiberglass, graphite, cork, polytetrafluoroethylene, polychlorotrifluoroethylene, and neoprene. In some embodiments, when coolant is poly-alpha-olefin oil, the gasket is formed substantially or completely of nitrile rubber with or without mineral fillers. The gasket may contain at least 80% nitrile rubber by weight. The gasket may contain at least 90% nitrile rubber by weight. The gasket may contain at least 99% nitrile rubber by weight.

In some embodiments, the coolant is poly-alpha-olefin, the gasket comprises nitrile rubber, and the clamping force that secures the gasket between the mating surfaces of the upper and lower portions of the housing enclosure may be a force of at least 5, at least 10, at least 15, at least 20, at least 25, at least 30, at least 40, at least 50, at least 60, at least 70, at least 80, at least 90, or at least 100 pounds per square inch.

One or more additional pumps (not shown) may be used to maintain a roughly constant pressure between multiple battery modules 210 connected in series (e.g., in string 212 in FIG. 2) and between such strings.

Liquid coolant may be pumped with a pump (not shown) through a heater and/or a cooler (not shown). The heater may raise the temperature of the coolant when necessary, for example, when the vehicle and/or the housing enclosure 200 is at a temperature lower than a desirable operating temperature. The heater may include an electric heater. The cooler may lower the temperature of the coolant when necessary, for example, when the vehicle and/or the housing enclosure 200 is at a temperature higher than a desirable operating temperature, such as due to a high ambient temperature, heat generated by battery modules 210, or heat generated by other components of the vehicle. The cooler may include a heat exchanger. The liquid coolant may then pass through coolant inlet 240 and may heat and/or cool the battery modules 210 as described above. Excess coolant may be stored a reservoir.

The coolant sub-system may circulate coolant within battery modules 210 (e.g., the circulation indicated by reference numeral 340). In some embodiments, the coolant may enter each battery module 210 through an interface 350. The coolant may flow through battery module 210. Interface 350 may be oriented to channel coolant into battery module 210 along the y-axis. Coolant may then be driven by pressure within the coolant system to flow out of battery module 210 through one or more channels 350B oriented along the x-axis. Coolant may then be collected at the two (opposite) side surfaces 360A and 360B of the module. Side surfaces 360A and 360B may be normal to the x-axis. In some embodiments, the coolant and sub-coolant systems may be used to maintain a substantially uniform and/or constant temperature within battery pack 140.

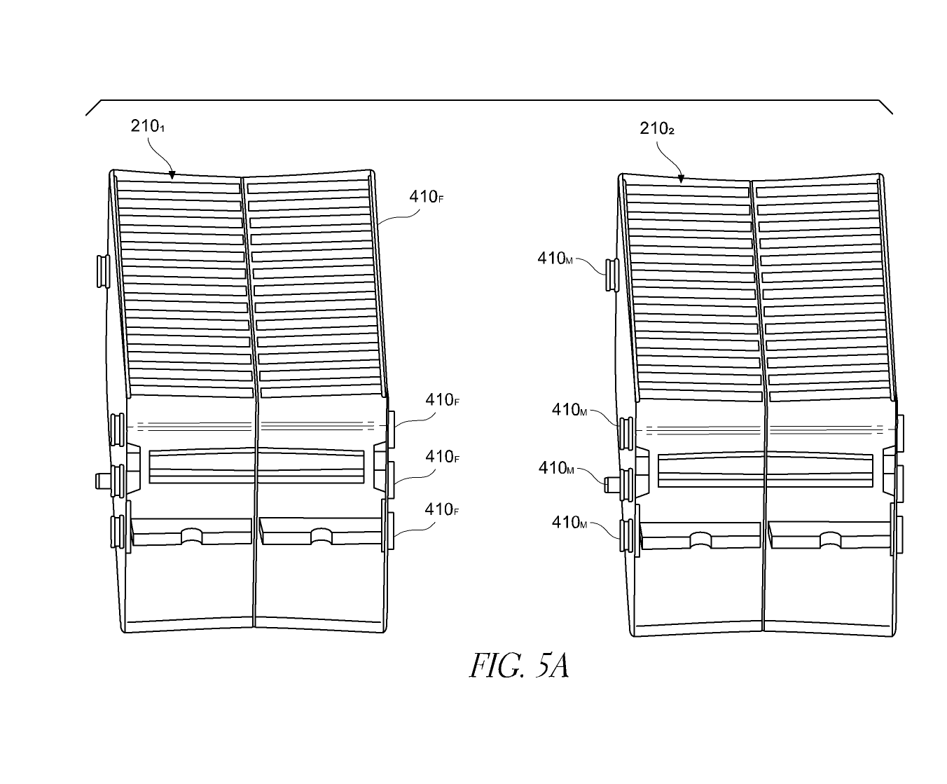

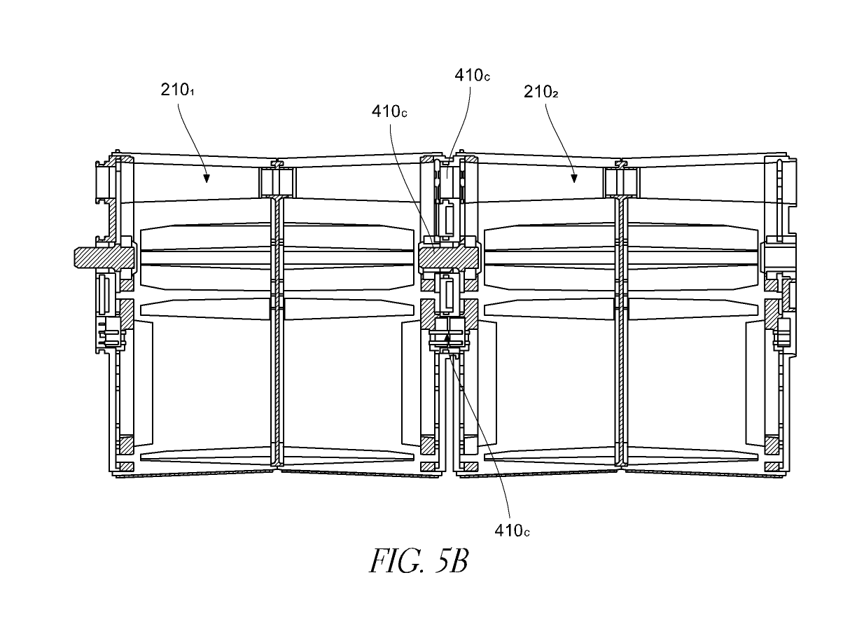

As discussed, exemplary battery pack 140 may include multiple battery modules 210. FIGS. 5A and 5B illustrate exemplary arrangements and couplings between two battery modules 210: 210₁ and 210₂. FIG. 5A depicts exemplary battery modules 210₁ and 210₂ separated but aligned for coupling. For example, battery modules 210₁ and 210₂ may be positioned as shown in FIG. 5A and then moved together until coupled as shown in the example in FIG. 5B. Generally, female connectors 410_{F} on one of battery modules 210₁ and 210₂ may receive and engage male connectors 410_{M} on the other of battery modules 210₂ and 210₁, respectively. One or more female-male connector pairings may be included on each of battery modules 210₁ and 210₂.

As shown in the example in FIG. 5A, a left side of battery modules 210₁ and 210₂ may have male connectors 410_{M}, and a right side of battery modules 210₁ and 210₂ may have female connectors 410_{F}. Alternatively, a mix of male connectors 410_{M} and female connectors 410_{F} may be used. Each female connector 410_{F} may include an (elastomer) o-ring or other seal. Male connectors 410_{M} and female connectors 410_{F} may act only as connection points or may also be power connectors, coolant ports, etc.

FIG. 5B depicts a cross-sectional view of exemplary battery modules 210₁ and 210₂ coupled together. For example, male connectors 410_{M} and female connectors 410_{F} combine to form coupled connectors 410_{C}. As discussed, male connectors 410_{M} and female connectors 410_{F} may be power connectors or coolant ports of battery modules 210. For example, one of male connectors 410_{M} may be a coolant output port of battery module 210₂, and one of female connectors 410_{F} may be a female coolant output port of battery module 210₁. Thus, the male and female ports may be coupled, and the internal cooling channels of the battery modules may be connected, for example, forming the cooling system schematically illustrated in FIGS. 4A and 4B. Similarly, multiple battery modules 210 may be electrically connected via a male connector 410_{M} and a female connector 410_{F} when coupled together.

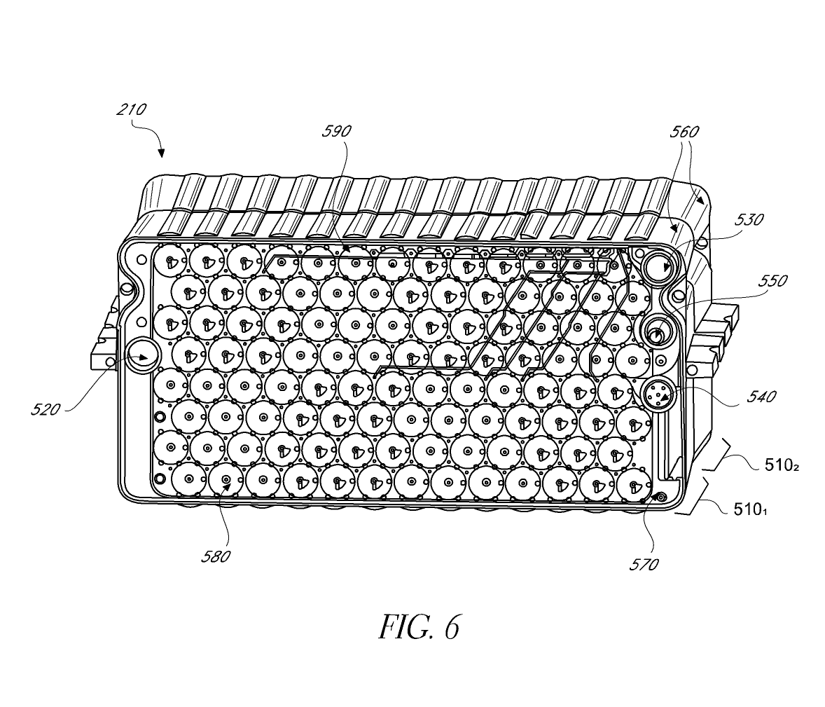

FIG. 6 is a diagrammatic illustration of an exemplary battery module 210. Battery module 210 may include two half modules 510₁ and 510₂, coolant input port 520, coolant output port 530, communications and low power connector 540, and/or main power connector 550.

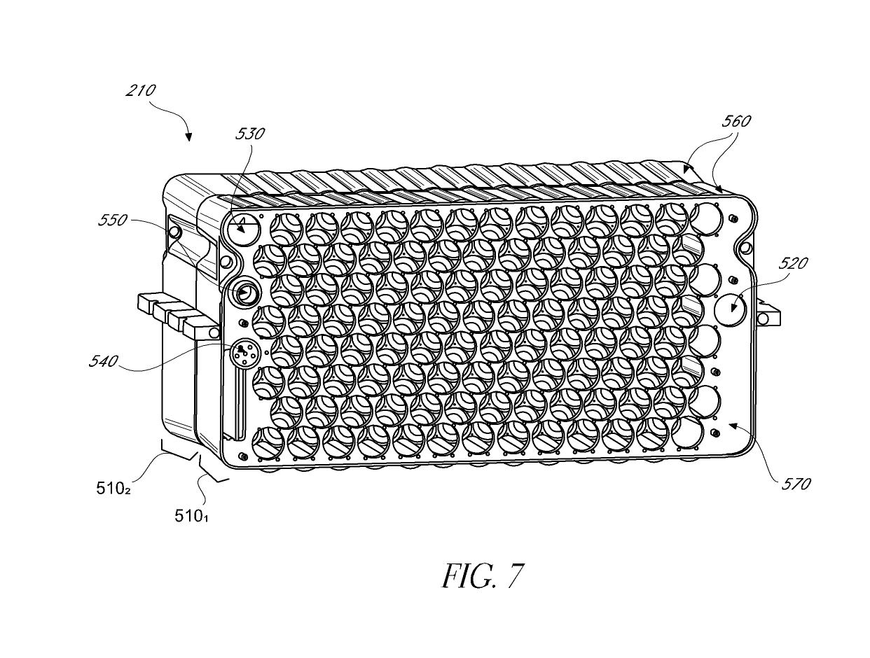

Each of half modules 510₁ and 510₂ may also include an enclosure 560 for housing battery cells therein. Enclosure 560 may further include a plate 570 (discussed in greater detail with respect to FIG. 7).

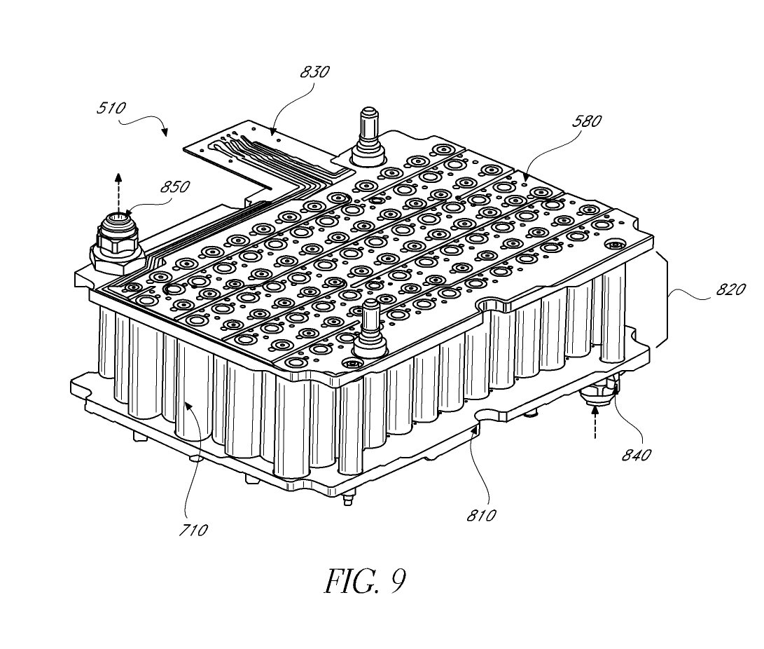

Half modules 510₁ and 510₂ of battery module 210 may further include a current carrier 580 (discussed in more detail with reference to FIG. 9), and may include one or more staking features 590, for example, a plastic stake, to hold current carrier 580 in battery module 210. Half modules 510₁ and 510₂ may be the same or may be different (e.g., half modules 510₁ and 510₂ may be mirror images of each other in some embodiments).

Coolant may be provided to battery module 210 at main coolant input port 520, circulated within battery module 210, and received at main coolant output port 530.

Communications and low power connector 540 may provide low power, for example, to electronics for data acquisition and/or control, and sensors. In some embodiments, communications and low power connector 540 may be at least partially electrically coupled to current carrier 580, for example, through electronics for data acquisition and/or control.

Each of coolant input port 520, coolant output port 530, communications and low power connector 540, and main power connector 550 may serve as male connectors 410_{M} and female connectors 410_{F}.

FIG. 7 is a diagrammatic illustration of battery module 210, with the battery cells and current carrier 580 removed from one of the half modules for illustrative purposes. As described, battery module 210 may include two half modules 510₁ and 510₂, main power connector 550, main coolant output port 530, main coolant input port 520, and communications and low power connector 540. Further, each of the half modules 510₁ and 510₂ may include enclosure 560.

Enclosure 560 may be made using one or more plastics having sufficiently low thermal conductivities. Respective enclosures 560 of each of the half modules may be coupled with one another other to form the housing for battery module 210. Enclosure 560 may additionally include a cover (not illustrated). Each enclosure 560 may further include plate 570 (e.g., a bracket). Plate 570 may include structures for securing the battery cells within enclosure 560 and maintaining the distance between battery cells.

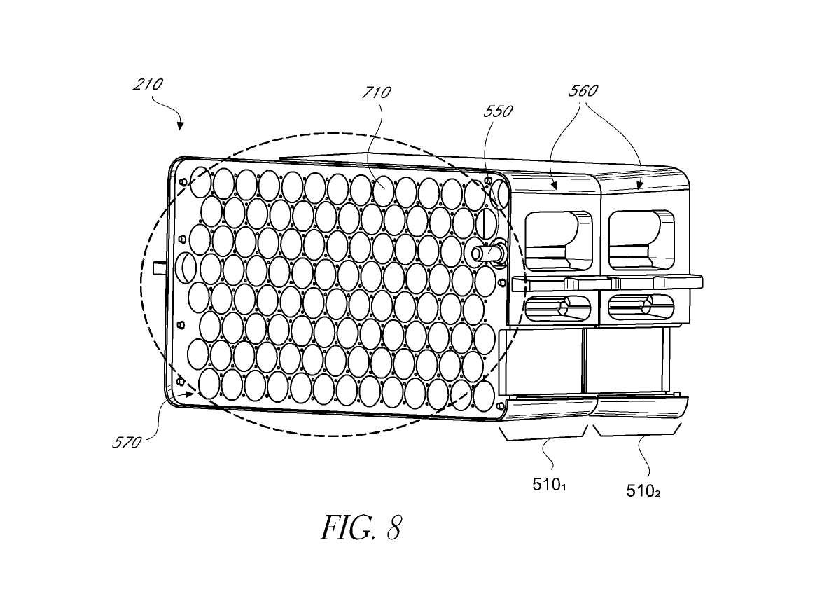

FIG. 8 is a diagrammatic illustration of an exemplary battery module 210, with current carrier 580 removed from one of the half modules for illustrative purposes. Each half module may include at least one battery cell 710. Main power connector 550 may provide power from battery cells 710 to outside of battery module 210.

FIG. 9 is a diagrammatic illustration of half module 510 without enclosure 560. Half module 510 may include a coolant intake 840 and a coolant egress 850, which may allow for use of the coolant sub-system discussed with reference to FIGS. 4A and 4B. Half module 510 may further include an electrical interface 830, which may be electrically connected to current carrier 580. Electrical interface 830 may be coupled to communications and low power connector 540. Half module 510 may also include a plurality of battery cells 710. Battery cells 710 may have a cylindrical body, and may be disposed between current carrier 580 and blast plate 810 in space 820, such that an exterior side of each of battery cells 710 may not be in contact with the exterior sides of other (e.g., adjacent) battery cells 710.

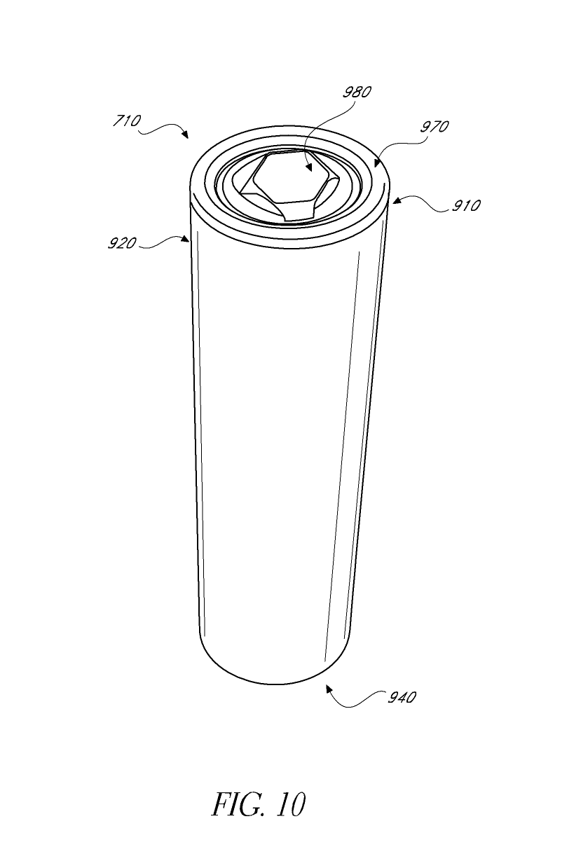

FIG. 10 depicts an exemplary battery cell 710. In some embodiments, battery cell 710 may be a lithium ion (li-ion) battery or any other type of battery. For example, battery cell 710 may be an 18650 type li-ion battery that may have a cylindrical shape with an approximate diameter of 18.6 mm and approximate length of 65.2 mm. Other rechargeable battery form factors and chemistries may additionally or alternatively be used. In various embodiments, battery cell 710 may include a first end 910, a can 920 (e.g., the cylindrical body), and a second end 940. Both an anode terminal 970 and a cathode terminal 980 may be disposed on first end 910. Anode terminal 970 may be a negative terminal of battery cell 710, and cathode terminal 980 may be a positive terminal of battery cell 710. Anode terminal 970 and cathode terminal 980 may be electrically isolated from each other by an insulator or dielectric.

Battery cell 710 may also include scoring on second end 940 to promote rupturing so as to effect venting in the event of over pressure. In various embodiments, all battery cells 710 may be oriented to allow venting into the blast plate 810 for both half modules.

Within half module 510, battery cells 710 may be disposed such that the cylindrical body of the battery cell may be parallel to the imaginary x-axis (“x-axis cell orientation”). According to some embodiments, x-axis cell orientation may offer additional safety and efficiency benefits. For example, in the event of a defect in half module 510 or battery module 210, the battery cells may be vented along the x-axis. Further, according to some embodiments, x-axis cell orientation may also be advantageous for efficient electrical and fluidic routing to each of battery module 210 in battery pack 140.

In addition, x-axis cell orientation may also be advantageous, according to some embodiments, for routing coolant (cooling fluid) in parallel to each of battery modules 210 in battery pack 140, for example, as may be seen in FIG. 9. Using the coolant systems described with reference to FIGS. 4A and 4B, coolant may enter half module 510 through coolant intake 840 and may exit through coolant egress 850. Coolant intake 840 and coolant egress 850 may each be male or female fluid fittings.

Channels 350B may be formed within the spaces between the cylindrical bodies of adjacent battery cells 710. Channels 350B may be metal tubes, but may also be spaces between the cylindrical bodies of battery cells 710, which may allow for higher battery cell density within battery module 210, in some embodiments by up to 15% or more. Channels 350B may or may not occupy the entire space between adjacent battery cells 710. Air pockets, which may reduce the weight of half module 510, may also be formed in the space between adjacent battery cells 710.

Such an exemplary parallel cooling system may be used to maintain the temperature of battery cells 710 within battery module 210 (and across battery back 140) at an approximately uniform level. According to some embodiments, the direct current internal resistance (DCIR) of each battery cell may vary with temperature; therefore, keeping each battery cell in battery pack 140 at a substantially uniform and predefined temperature range may allow each battery cell to have substantially the same DCIR. Voltage across each battery cell may be reduced as a function of its respective DCIR, and therefore each battery cell 710 in battery pack 140 may experience substantially the same loss in voltage. In this exemplary way, according to some embodiments, each battery cell 710 in battery pack 140 may be maintained at approximately the same capacity, and imbalances between battery cells 710 in battery pack 140 may be reduced and/or minimized.

According to some embodiments, each of half modules 510₁ and 510₂ may include the same number of battery cells 710. In various embodiments, each half module may include a number of battery cells 710 in the range of 20, 50, 100, 200, or more. For example, each half module may include one hundred-four battery cells 710. Battery cells 710 may be electrically connected via current carrier 580. For example, thirteen of battery cells 710 may form a group and may be electrically connected in parallel, with a total of eight of such groups of thirteen battery cells 710 electrically connected in series. This exemplary configuration may be referred to as “8S13P” (8 series, 13 parallel). Other combinations and permutations of battery cells 710 electrically coupled in series and/or parallel may be used.

In various embodiments, battery half modules 510₁ and 510₂ may include a current carrier 580 configured to connect the terminals of a plurality of electrochemical battery cells. For example, the current carrier 580 may include a plurality of wires, a flex circuit, or the like. Various embodiments may include flex circuits as current carriers 580. A flex circuit may provide various advantages, such as flexibility, durability, and ease of manufacture (e.g., a flex circuit designed for a particular configuration of battery cells may be placed on top of the configured battery cells and secured in place, avoiding the need for additional wiring or other complex electrical connections. Without limiting the scope of current carriers that may be included with the battery systems described herein, an example embodiment of a current carrier will now be described.

Current carrier 580 may include a printed circuit board and a flexible printed circuit. For example, the printed circuit board may variously include at least one of copper, FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (non-woven glass and epoxy), CEM-4 (woven glass and epoxy), and CEM-5 (woven glass and polyester). By way of further non-limiting example, the flexible printed circuit may include at least one of copper foil and a flexible polymer film, such as polyester (PET), polyimide (PI), polyethylene naphthalate (PEN), polyetherimide (PEI), along with various fluoropolymers (FEP), and copolymers.

According to some embodiments, current carrier 580 may provide electrical connectivity between and among battery cells 710. As noted, current carrier 580 may be electrically connected to a plurality of battery cells 710, and may connect battery cells 710 in series or in parallel.

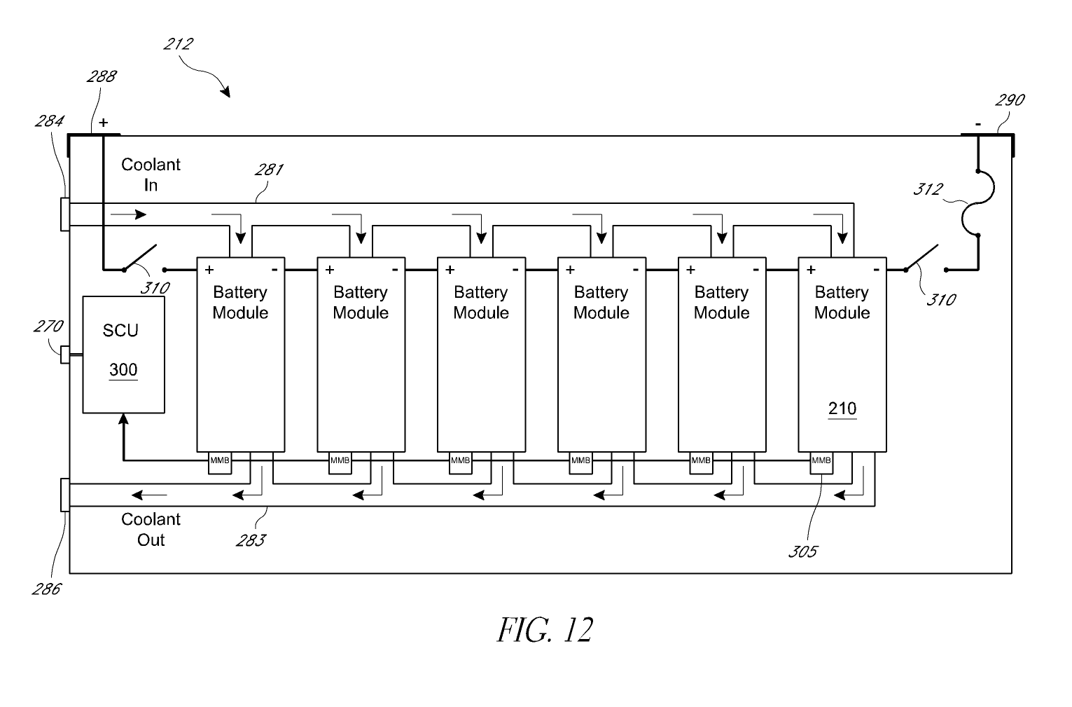

FIG. 12 schematically illustrates various components of a modular battery string 212 in accordance with an exemplary embodiment. A battery string 212 may include one or more battery modules 210 configured to provide high voltage power to a vehicle powertrain. The battery string 212 may further include a coolant circulation system, such as one or more coolant intake conduits 281 and coolant outlet conduits 283, and monitoring and/or control circuitry, such as a string control unit (SCU) 300. The battery string 212 may include external connections as described above, such as a positive high-voltage connector 288 and negative high-voltage connector 290 for the battery modules 210, auxiliary connector 270 for the SCU 300, a coolant inlet 284 for the coolant intake conduit 281, and a coolant outlet 286 for the coolant outlet conduit 283.

The battery pack 140 may further include a cooling system, such as a liquid cooling system, to control the operating temperature of components within the battery strings 212. The cooling system may include one or more conduits (e.g., coolant supply conduit 280 and coolant return conduit 282) configured to carry liquid coolant to and from the battery strings. Conduits 280 and 282 may connect to the battery strings 212 at inlets 284 and outlets 286, which may include sealable valves, dry breaks, or other breakable liquid connections. In some embodiments, the conduits 280 and 282 may be manually connectable, such that a user can connect a supply conduit 280 to the coolant inlet 284 and connect a return conduit 282 to the coolant outlet 286 after placing a battery string 212 into an available space within the battery pack 140. The cooling system may further include elements such as a heat exchanger, pump, reservoir, or other components (not shown) in fluid communication with the conduits, to store, circulate, and cool the liquid coolant.

The strings 212 may be connected in parallel, in series, or in a combination of parallel and series connections. Each string 212 may have a positive high voltage connector (not shown) and a negative high voltage connector (not shown) for charging and for delivery of electricity to systems of the vehicle. In some embodiments, a current carrier (not shown), such as a bus bar or flexible conduit, may be located within or adjacent to one or more lower support elements such as tray 260. For example, current carriers disposed within tray 260 may allow connections with the high voltage connectors to be made through or near a positioning member (not shown) and assisted by gravity.

Battery modules 210 may be connected in parallel, in series, or in a combination of parallel and series connections within the battery string 212. For example, the six modules 210 depicted in FIG. 12 are connected in series so as to produce a total string voltage of up to six times the voltage of each module 210. The modules 210 may be electrically connected to the positive high-voltage connector 288 and the negative high-voltage connector 290 to deliver electrical power to vehicle systems. The modules 210 may be separable from the vehicle power circuit by one or more circuit interruption elements, such as contactors 310 and/or one or more fusible elements 312. A fusible element 312 may be included as a redundant circuit disconnection device, for example, configured to open the circuit if a contactor 310 fails. In some embodiments, a fusible element 312 may be a passive fuse, thermal cutoff, or the like. The fusible element 312 may also be a selectively blowable fuse configured to blow based on an electrical or thermal input produced in response to a detected contactor failure or other malfunction.

In various embodiments, one or more contactors 310 may be used to control current flow through the battery modules 210. Although one contactor 310 may typically be sufficient to open the circuit through the battery modules 210 and prevent current flow, two contactors 310 may be used for additional control and/or redundancy (e.g., in case of a contactor welding event or other malfunction). Contactors 310 may be located within the battery string 212 and/or outside the battery string 212, such as within the circuitry connecting the battery string 212 to the main high-voltage electrical circuit of the vehicle. Locating the contactors 310 within the battery string 212 may provide enhanced safety. For example, the contactors 310 may be normally open contactors operable only when the string is installed within the vehicle (e.g., powered by the SCU 300, which may be powered when connected to low-voltage vehicle power at the auxiliary connector 270), such that an inadvertent connection between the high-voltage connectors 288 and 290 will not cause current to flow from the battery modules 210 when the battery string 212 is not installed within a vehicle.

The battery modules 210 and other structures within the string 212 may be monitored and/or controlled by one or more module monitoring boards (MMBs) 305 and a string control unit (SCU) 300. In some embodiments, each battery module 210 may have an associated MMB 305. An MMB 305 connected to a battery module 210 may monitor any characteristic or status of the module 210. For example, the MMB 305 may monitor any one or a combination of battery module 210 temperature, coolant temperature, one or more individual battery cell temperatures, current flow into or out of the battery module 210, current flow at a location within the battery module 210, an open circuit voltage of the battery module 210, a voltage between two points within the battery module 210, a charge state of the battery module 210, a detected status such as a fault or alarm generated by a sensor within the battery module 210, or the like.

The MMBs 305 may be connected to the SCU 300 by a wired or wireless connection. In some embodiments, each MMB 305 may be connected directly to the SCU 300, or the MMBs 305 may be connected in a chain, with one or a subset of MMBs 305 connected directly to the SCU 300. The connections between the MMBs 305 and the SCU 300 may allow any of the data collected at the MMBs 305 to be transmitted from the MMB 305 to the SCU 300, such as for analysis, monitoring, or the like. The SCU 300 may include one or more processors, memory units, input/output devices, or other components for storing, analyzing, and/or transmitting data. In some embodiments, a wired connection between the SCU 300 and one or more MMBs 305 may allow the MMBs 305 to draw electrical power for operation from the SCU 300. At the SCU 300, global monitoring and/or control functions may be performed for the battery string 212. For example, the SCU 300 may monitor any characteristic or status of the battery string 212, or of any one or combination of the battery modules 210 within the string 212, such as a temperature, current, voltage, charge state, detected status such as a fault or alarm, or the like. The SCU 300 may control the operation of the battery string 212, such as by causing one or more circuit interruption elements (e.g., contactors 310) to close or open so as to allow current to flow or stop current flow between the battery modules 210 and the high voltage connectors 288 and 290.

The SCU 300 may be connected to an auxiliary connector 270 of the battery string 212 to receive power, receive data, and/or transmit data to other vehicle systems. For example, the auxiliary connector 270 may include a CAN bus connector, other data connector, a power connector, or the like. The SCU 300 may communicate any characteristic or status, or other information determined based on a characteristic or status of at least a portion of the string 212, to other systems of the vehicle through a vehicle wiring connector (not shown) connected to the battery string 212 at the auxiliary connector 270. In some embodiments, the auxiliary connector 270 may be further configured to draw current from a vehicle wiring connector (not shown) and deliver electrical power to the SCU 300, such as for operation of electrical components of the SCU 300 and/or MMBs 305.

The battery string 212 may include one or more internal conduits 281, 283 for liquid coolant. As described above, coolant may enter the battery string 212 from an external conduit (not shown) at an inlet 284 and leave the battery string 212 at an outlet 286. Upon entering the battery string at the inlet 284, coolant may travel through an internal coolant intake conduit 281 to enter one of the battery modules 210. After traveling through a battery module 210, where the coolant may absorb heat from one or more components of the battery module 210 (e.g., electrochemical battery cells, internal electronic components, or the like), the coolant may travel through an internal coolant outlet conduit 283 to the coolant outlet 286, where it may return to the external cooling system. As described above, coolant leaving at the outlet 286 may be propelled by one or more pumps (not shown) to a heat exchanger, reservoir, and/or other components of the cooling system.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity. Where a range of values is provided, it is understood that the upper and lower limit, and each intervening value between the upper and lower limit of the range is encompassed within the embodiments.

It is noted that this disclosure may describe a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

It will be appreciated by those skilled in the art that various modifications and changes may be made without departing from the scope of the described technology. Such modifications and changes are intended to fall within the scope of the embodiments, as defined by the appended claims. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged, or excluded from other embodiments.

Those of skill would further appreciate that any of the various illustrative schematic drawings described in connection with the aspects disclosed herein may be implemented as electronic hardware (e.g., a digital implementation, an analog implementation, or a combination of the two, which may be designed using source coding or some other technique), various forms of program or design code incorporating instructions, or combinations of both.

The various circuitry, controllers, microcontroller, or switches, and the like, that are disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both.

The functions described may be implemented in hardware, software, firmware, or any combination thereof. If implemented in software, the functions may be stored on or transmitted over as one or more instructions or code on a tangible, non-transitory computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. A computer-readable medium may be in the form of a non-transitory or transitory computer-readable medium.

Though described herein with respect to a vehicle, as would be readily appreciated by one of ordinary skill in the art, various embodiments described herein may be used in additional applications, such as in energy-storage systems for wind and solar power generation. Other embodiments will be apparent to those skilled in the art from consideration of the specification and practice of the disclosed current carrier and battery module. It is intended that the specification and examples be considered as exemplary only, with a true scope being indicated by the following claims and their equivalents.

1. An electric vehicle, comprising:
a housing enclosure comprising an upper portion and a lower portion,
wherein the upper portion comprises a mating surface and the lower portion comprises a mating surface, and
wherein the mating surface of the upper portion is configured to mate with the mating surface of the lower portion;
a plurality of battery modules disposed within the housing enclosure,
wherein each battery module comprises a plurality of rechargeable electrochemical cells;
a cooling system configured to supply coolant to the battery modules disposed within the housing enclosure,
wherein the cooling system comprises one or more coolant inlets capable of providing one or more coolant flow paths into the housing enclosure,
wherein the cooling system comprises one or more coolant outlets capable of providing one or more coolant flow paths out of the housing enclosure, and
wherein the coolant comprises poly-alpha-olefin oil;
a gasket positioned between the mating surfaces of the upper and lower portions of the housing enclosure,
four or more bolts or screws providing a clamping force that compresses the gasket between the mating surfaces of the upper and lower portions of the housing enclosure to form a seal between the mating surfaces of the upper and lower portions of the housing enclosure,
wherein the seal prevents ingress and egress of the coolant through the mating surfaces of the upper and lower portions of the housing enclosure, and
wherein the gasket comprises nitrile rubber.

2. The electric vehicle of claim 1, wherein the poly-alpha-olefin oil is a polymer oil comprising 1-decene or 1-dodecene monomer units.

3. The electric vehicle of claim 1, wherein the nitrile rubber is a copolymer of 2-propenenitrile and butadiene monomer units, and wherein the copolymer comprises a range of 30%-45% 2-propenitrile monomer units.

4. The electric vehicle of claim 3, wherein the copolymer comprises a range of 30%-35% 2-propenitrile monomer units.

5. The electric vehicle of claim 1, wherein the gasket is compressed by a clamping force of at least 25 pounds per square inch.

6. The electric vehicle of claim 1, wherein a torque of at least 25 foot-pounds is applied to each of the four or more bolts or screws.

7. The electric vehicle of claim 1, wherein the gasket positioned between the mating surfaces of the upper and lower portions of the housing enclosure has a thickness of 0.010-0.200 inches in its non-compressed state.

8. An electric vehicle, comprising:
a housing enclosure comprising an upper portion and a lower portion,
wherein the upper portion comprises a mating surface and the lower portion comprises a mating surface, and
wherein the mating surface of the upper portion is configured to mate with the mating surface of the lower portion;
a plurality of battery modules disposed within the housing enclosure,
wherein each battery module comprises a plurality of rechargeable electrochemical cells;
a cooling system configured to supply coolant to the battery modules disposed within the housing enclosure,
wherein the cooling system comprises one or more coolant inlets capable of providing one or more coolant flow paths into the housing enclosure,
wherein the cooling system comprises one or more coolant outlets capable of providing one or more coolant flow paths out of the housing enclosure, and
wherein the coolant comprises poly-alpha-olefin oil;
a gasket positioned between the mating surfaces of the upper and lower portions of the housing enclosure,
a means for compressing the gasket between the mating surfaces of the upper and lower portions of the housing enclosure to form a seal between the mating surfaces of the upper and lower portions of the housing enclosure,
wherein the seal prevents ingress and egress of the coolant through the mating surfaces of the upper and lower portions of the housing enclosure, and
wherein the gasket comprises nitrile rubber.

9. The electric vehicle of claim 8, wherein the poly-alpha-olefin oil is a polymer oil comprising 1-decene or 1-dodecene monomer units.

10. The electric vehicle of claim 8, wherein the nitrile rubber is a copolymer of 2-propenenitrile and butadiene monomer units, and wherein the copolymer comprises a range of 30%-45% 2-propenitrile monomer units.

11. The electric vehicle of claim 10, wherein the copolymer comprises a range of 30%-35% 2-propenitrile monomer units.

12. The electric vehicle of claim 8, wherein the means for compressing the gasket produces a clamping force of at least 25 pounds per square inch.

13. The electric vehicle of claim 8, wherein the means for compressing the gasket includes four or more bolts or screws, wherein each of the bolts or screws are tightened with a torque of at least 25 foot-pounds.

14. The electric vehicle of claim 8, wherein the gasket positioned between the mating surfaces of the upper and lower portions of the housing enclosure has a thickness of 0.010-0.200 inches in its non-compressed state.

15. A method of preventing leakage of coolant within an electric vehicle, the method comprising:
placing a gasket between mating surfaces of a battery module housing enclosure,
wherein the battery module housing enclosure comprises an upper portion and a lower portion,
wherein the upper portion comprises a mating surface and the lower portion comprises a mating surface,
wherein the mating surface of the upper portion is configured to mate with the mating surface of the lower portion,
wherein the battery module housing enclosure contains a plurality of battery modules disposed within the housing enclosure,
wherein each battery module comprises a plurality of rechargeable electrochemical cells, and
wherein the gasket comprises nitrile rubber;
compressing the gasket between the mating surfaces of the upper and lower portions of the housing enclosure to form a seal between the mating surfaces of the upper and lower portions of the housing enclosure;
flowing a coolant into the battery module housing enclosure through one or more coolant inlets,
wherein the coolant flows into each of the battery modules disposed within the battery module housing enclosure,
wherein the coolant flows out of each of the battery modules,
wherein the coolant further flows out of the battery module housing enclosure through one or more coolant outlets,
wherein the coolant comprises poly-alpha-olefin oil; and
wherein the seal formed by the gasket prevents ingress and egress of the coolant through the mating surfaces of the upper and lower portions of the housing enclosure.

16. The method of claim 15, wherein the poly-alpha-olefin oil is a polymer oil comprising 1-decene or 1-dodecene monomer units.

17. The method of claim 15, wherein the nitrile rubber is a copolymer of 2-propenenitrile and butadiene monomer units, and wherein the copolymer comprises a range of 30%-45% 2-propenitrile monomer units.

18. The method of claim 17, wherein the copolymer comprises a range of 30%-35% 2-propenitrile monomer units.

19. The method of claim 15, wherein the gasket is compressed by a force of at least 25 pounds per square inch.

20. The method of claim 15, wherein the gasket is compressed by four or more bolts or screws, wherein each of the bolts or screws are tightened with a torque of at least 25 foot-pounds.

21. The method of claim 15, wherein the gasket that is placed between the mating surfaces of the upper and lower portions of the housing enclosure has a thickness of 0.010-0.200 inches before it is compressed.
